(19) United States
(12) Patent Application Publication
(10) Pub. No.: US 2004/0261115 A1
(43) Pub. Date: Dec. 23, 2004

(54) Voice over IP receiver assisted call control

(76) Inventor: Eyal Bartfeld, Lexington, MA (US)

Correspondence Address: SALTAMAR INNOVATIONS, 30 FERN LANE, SOUTH PORTLAND, ME, 04106, US

(21) Appl. No.: 10/870,613

(22) Filed: Jun. 17, 2004

Related U.S. Application Data
(60) Provisional application No. 60/480,715, filed on Jun. 23, 2003.

(51) Int. Cl. H04M 1/64; H04N 7/173; H04L 12/66

(52) U.S. Cl. 725/106; 379/88.17; 725/122

(57) ABSTRACT

A system for viewing of selected telephone call parameters and optionally controlling phone calls at a subscriber receiving location, having a telephony-television gateway (TTG) coupled to a public television distribution system, for displaying call information on a display device associated with a subscriber. A VoIP enabled receiver (VER) installed at the subscriber premises, and adapted to receive an incoming telephone conversation and call control data from a call processor. The VER is adapted to send call control data to a predetermined TTG. The TTG is receive said call control data from the VER, and send information to cause display of selected portions of the call control data on the display device. The most common call control data to be displayed is information identifying the calling party (Caller ID or CID), or the telephone number of the originating telephone, or a combination thereof. Other information may include call time, specific indications related to the caller, as well as advertisement, and the like.

The invention allows for interconnection between VOIP telephony and television display of call parameters and optionally call control activities, using television, without requiring the direct coupling between a call processor and a telephony-television interface, as the connection occurs via the VER. The invention therefore simplifies the customization required for a direct coupling of a TTG and telephony service in a VOIP environment.

### RELATED APPLICATIONS

This application claims the right of priority of U.S. provisional application No. 60/480,715, filed June 23 2003, which is incorporated herein by reference in its entirety.

### FIELD OF THE INVENTION

The present invention relates generally to controlling telephone calls in a VoIP (voice over Internet Protocol) environment and more specifically to displaying incoming call parameters on a display external to a telephone and allowing the user control over the call using an input device.

### BACKGROUND OF THE INVENTION

In these specifications, the following terms imply, unless otherwise stated or made clear by the context:

TTG: Telephony Television Gateway, meaning a device adapted, inter alia, to receive information regarding telephony operations such as caller ID and call control, and transmit the information via a public television distribution system for display on a specific Display Device (see below), such as a television at the premises of the called party. Preferably, the TTG is also adapted to receive commands from the called party via the distribution system, and direct those commands to a telephony system or a VER (see below), to affect certain call related operations.

VER or Receiver: VoIP Enabled Receiver. The terms Receiver and VER are used interchangeably. The Receiver communicates with a Call Processor (see below) over an IP (Internet Protocol) link, and converts VoIP information to a format compatible with a telephony device or a telephony enabled device. Thus the VER acts as a recipient of the VoIP information or as a converter between the telephony and the IP domains, and preferably allows regular telephones, digital telephones, and other telephony equipment to utilize VoIP instead of a PSTN telephony services. Another function of the Receiver is to receive and interpret call control messages sent to it from the Call processor. These messages or information is not part of the audio portion of the call, but rather contains information about the call, such as caller ID and caller name (if known), call disconnect, ring event an the like. The Receiver also generates control messages to the Call processor. These messages are for example, dial command, hangup event, and the like. Examples of VER's include but are not limited to: Cable modem containing voice capability (this component is also known as MTA (Media Terminal Adapter) or EMTA (Embedded Media Terminal Adapter)), a PC (personal Computer) equipped with software and hardware to act as a VER, certain set-top boxes (television terminal in the user premises to receive signals from the public television distribution system and convert those signals for display on a television), and the like. It should however be noted that a PC may be coupled to hardware or software that can cause the PC to act as the telephony device as well. The VER is located at a user premises.

Display Device: a data protocol enabled display device, such as a television, a video monitor, a PC (Personal Computer), a digital set-top box (in combination with a television or a monitor) and the like. Preferably, the display device also has the capacity to play audio information. The display device may also be coupled to an input device such as a television remote control, and the like.

Call Processor: interchangeably referred to as a soft-switch, or a telephony call processor. In a VoIP environment this is a central system that performs functions analogous to a telephone switch. A Call Processor communicates with a Receiver over IP link.

There presently exist systems that allow a subscriber to view selected information related to a telephone call on a television. A common system extracts telephone call parameters directly from information present on the telephone line (the most popular is caller-ID information), and locally convert the parameters for display of on a television screen. U.S. Pat. Nos. 5,805,677 and 6,052,444 to Ferry et al. represent examples of this approach wherein an apparatus (commercially known as “TV Messenger”) located at the subscriber premises, is connected to a telephone line and outputs a video signal that causes a display of caller ID information when the phone rings. These systems require physical connection to a telephone line as end user equipment that extracts the parameters from the telephone line and displays them on the television screen.

Another way of performing call related information display on TV and potentially allow the user to control phone calls via the TV remote control unit is by having a TTG coupled to a telephony switch. This approach requires a special integration of the TTG with a central telephone switch such as described in U.S. patent application Ser. No. 10/189,269 to Bartfeld et al. This application is incorporated herein by reference in its entirety. This integration of the TTG with a switch is often proprietary, costly to develop, debug, and maintain.

### SUMMARY OF THE INVENTION

In common VoIP architecture, the VER contains logic that interprets call related parameters which are received from the Call Processor. While the traditional telephone systems are designed to accommodate a simple telephony device at the called end, and the data transmission is similarly constructed, the VER in a VoIP environment can incorporate additional logic that would allow it to copy (in either raw format or a modified format) certain information it receives from the Call Processor to a TTG preferably located at a central location. This way the TTG can, in real-time, have the call parameters, such as caller ID, without having to interact at all with the Call Processor. As the VER already contains logic to decode the IP encoded voice, the addition of the copy function can be achieved without adding significant costs. Additionally, a fast data connection already exists between the VER and the TTG that is not available in traditional telephone networks.

In its most preferred embodiment, the present invention provides a system for viewing of selected telephone call parameters and controlling phone calls at a subscriber receiving location, the system having at least one VOIP Enabled Receiver and a Display Device as an output and preferably also as input device for call display and control, and a TTG coupling the telephone call information to the Display Device. The VER is located at the subscriber premises or in proximity thereto.

Therefore, there is provided a telephone call control system comprising a telephony-television gateway (TTG) adapted to be coupled to a public television distribution system, and send information therethrough, for displaying or audibly producing said information on a particular display device associated with a subscriber. A VoIP enabled receiver installed at the subscriber premises, and adapted to receive an incoming telephone conversation and call control data, from a call processor. The VOIP enabled receiver further adapted to send at least a portion of said call control data to a predetermined TTG. The TTG is further adapted to receive said call control data from said VOIP enabled receiver, and send information to cause display of at least selected portions of said call control data on said display device. The most common call control data to be displayed is information identifying the calling party (Caller ID or CID), or the telephone number of the originating telephone, or a combination thereof. Other information may include call time, specific indications related to the caller, and the like.

Preferably, the TTG is further adapted to receive commands 710, 810 from the user and transfer 720 said commands to said call processor. Such commands may include, but are not limited to, commands to disconnect the call, commands to direct the incoming call to a voice mail system, and the like. If the TTG is adapted to receive voice information from the call voice mail system, it preferably is further adapted to, responsive to a user command, receive the voice data of a message 730 as it is being recorded, and deliver the voice data to the display device 740 for audible replay thereon. Additional commands may be provided for redirecting the call back 810 to the VER associated with the user, or to another destination such as an alternative telephone 815, alternative VER, and the like. Also optionally, the TTG is adapted to send commands to the VER to cause the VER to perform predetermined operations such as instruct the VER to initiate a call, report certain events, such as the termination of a call, and the like.

In its most preferred embodiment, the TTG is further adapted to simultaneously display advertisement information on the display device, combined with the call control information.

Another aspect of the present invention provides a Voice Enabled Receiver (VER) comprising an IP receiver adapted to receive packets containing telephony call information comprising voice data and call control data, the receiver further adapted to convert the voice data into an audio signal suitable for reproduction on a telephony device. An IP transmitter is adapted to receive voice from the telephony device and convert said voice into outgoing voice data packets, and transmit the outgoing packets. A control data transmitter module adapted to send said call control data to a predetermined telephony-television gateway adapted to cause displaying of at least a portion of said call control data on a display device.

In yet another aspect of the present invention there is provided a method of obtaining VOIP based telephone call control data comprising the steps of:

receiving packets comprising call control data in a VOIP enabled receiver; transmitting said packets or a portion thereof to a predetermined central telephony-television gateway coupled to a television or data distribution network.

In yet another aspect of the present invention there is provided a method of providing VOIP based telephone call control to a subscriber, the method comprises the steps of:

at a subscriber premises, receiving packets comprising call control data in a VOIP enabled receiver;

transmitting said packets or a portion thereof to a predetermined central telephony-television gateway coupled to a television or data distribution network; and,

sending a signal adapted to cause display of said call control information or a portion thereof on a display device at said user premises, preferably via said television distribution network.

It is a feature of the preferred embodiment of the present invention that the Display Device becomes an interactive telephone call control center, whereby pressing buttons on the TV remote control keypad for example, causes the telephone call to be re-routed to a different destination.

For the purpose of this invention, the telephone Call processor can be coupled to any digital network capable of distributing VoIP phone calls, including but not limited to a cable-TV network, xDSL, satellite, terrestrial, wireless or cellular.

According to a preferred embodiment of the invention, the TTG comprises a CPU and memory module, one or more communication ports such as LAN, and a storage device such as a disk drive.

Further according to a preferred embodiment of the invention, the TTG can provide message waiting notification on the Display Device by having the Receiver notify the TTG of a message wafting signal it received from the Call Processor or from a voice messaging system attached to the Call processor.

### BRIEF DESCRIPTION OF THE DRAWINGS

The present invention will be better understood and appreciated with aid from the following detailed description taken in conjunction with the drawings in which:

FIG. 1 is a schematic diagram of one embodiment of the invention operated over a cable-TV network that also provides digital voice telephony service.

FIG. 2 is an example of a flow chart of logic added to a VER for the purpose of supporting TTG operation, to be executed during call receiving process according to the preferred embodiment of the invention.

FIG. 3 is a simplified flow diagram executed by the VER in response to a command from the TTG to generate a new call.

FIG. 4 is an example of a flow chart of a program embedded in a TTG to provide a caller ID on a Display device, working in conjunction with a VER.

FIG. 5 is an example of a program embedded in a TTG to provide a dial by phone book capability.

FIG. 6 is a schematic diagram of one embodiment of TTG apparatus.

FIG. 7 is a simplified schematic diagram of delivery of a voice mail message to the display device.

FIG. 8 is a simplified schematic diagram of redirecting a telephony session.

### DETAILED DESCRIPTION OF THE INVENTION

The present invention is particularly suitable for use in situations where a communication service provider like cable-TV service provider, or a telephone company that provides TV services over a high-speed connection to the subscriber home. The value of service and the market success of such service providers depends upon the ease of use and user-friendly access that these service providers offer their subscribers. Viewing call related parameters and call management are examples of these services. The example given is of a cable-TV network operator or MSO (Multiple Services Operator) that also provides telephony services. As it is a goal of the present invention to provide call related information and control over a Display device, for example, a TV, there is a need to deliver information generated by one system—that is either the telephony system or the Television system, to the other system, in real-time.

The present invention involves having one or more TTG's 109 interact with a plurality of VERs 107 installed at the user premises e.g. a home. This interaction typically occurs over a data-network coupling between the VER and the TTG. According to the present invention, the VER reports events over the data network to the TTG. The TTG can also instruct the VER to issue call related commands back to the Call processor, emulating operations otherwise performed by a subscriber, as if the subscriber manually or otherwise has caused these commands to be sent. Optionally, a VER can be embedded inside a Display device, again assuming that the Receiver and the Display device are connected over the same data network.

The VER 107 by its nature is an IP enabled device. It is constructed to receive telephone sessions, together with call control information, such as caller ID information. The data arrives at the VER as IP packets and is being transformed by the VER to a telephony signal. According to some aspects of the present invention the VER is constructed with logic that sends a copy of at least some call control information, to a TTG 109 when such information is received, together with information identifying the VER. Thus the TTG is aware of the call details. Preferably, the information is sent via IP.

Preferably, the TTG apparatus is a computer system that comprises at least two network interfaces. One network interface couples the TTG directly or indirectly to a VER via a data network, and the other network interface couples the TTG to the Display device or devices. In cases where the display devices and the VER are on the same network (e.g. a cable television network), a single network interface will suffice. Similarly other data paths, also referred to as data links, can be combined on one or more physical networks, or traverse intermediate networks and network types as needed to provide an information transfer path as required.

The TTG is constructed to access a data table, stored in any convenient manner, that relates a called address, such as called telephone number, to one or more digital set-top boxes or PC's, and the like. When the TTG receives a call detail message from the VER, locates the relevant display device or devices address or addresses, generate the appropriate display or display instructions, and send those instructions to the appropriate display device destination. The instructions may be by video, or as data such as IP data, private data in a JPEG based stream, vertical blank intervals data, and the like.

According to an optional embodiment of this invention, the signal sent from a central call processor 103 to a VER located at the subscriber location comprises a message waiting indication signal. This signal indicates the presence of a message waiting or the absence of a message waiting. The VER can then replicate the message waiting signal, or generate a new message that is sent to the TTG. The TTG receives and interprets this information, and for example causes set a special icon on the Display device or devices, or assert other notification indicator on the display device at the user premises.

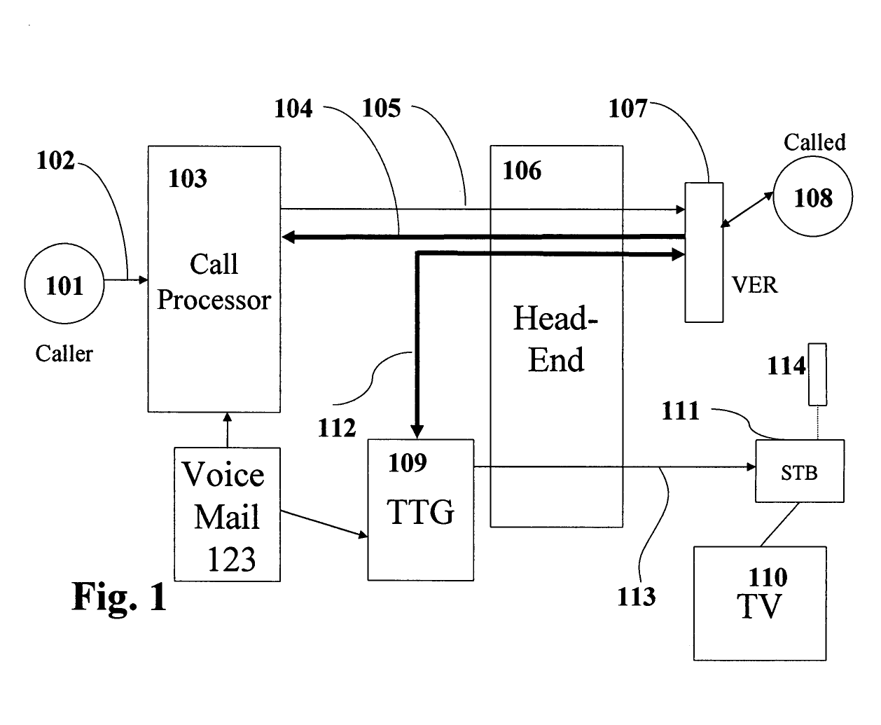

Referring now to FIG. 1, there is shown a schematic diagram showing a preferred embodiment of the invention. The environment where the system is used in this figure is a cable television/telephony network that further includes a Call processor 103, a TTG 109, one or more VER's 107, and one or more set-top boxes 111 and Televisions 110. Set-top box 111 and Television 110 together perform the function of a Display device. It should be noted that elements such as: Call processor and central TTG need not necessarily be located at the same location, or operated by the same operator, and different companies or operators can own these components, as long as they are connected in a way enabling those components to operate and transfer data in the manner described herein. By referring to head-end 106 we mean any facilities that are used for the delivery of digital video, and/or high-speed data connection from a central location to a plurality of user premises. The video distribution and data distribution facilities need not necessarily be on the same network or operated by the same operator. In this preferred embodiment, the call processor 103 is coupled to the cable network for delivering the calls to residents' homes, and is further connected to the public telephony network 102, and optionally, can be connected also to other Call processors or telephony switches in the cable operator's network, or outside of it (not shown). Preferably, the cable network delivers video in digital form.

Similarly, it should be recognized that the display device may be a variety of types, and that a display device will commonly (however not necessarily) be made of two or more separate device such as a set-top box and a television, and the like.

When a telephone call arrives for a subscriber, the call processor 103 directs the call via the head-end 106 and network to a telephone 108 located at the subscriber's location. Transferring the call to the subscriber's phone 108 can be achieved by either using the same cables that are used for transmitting video, or using a separate network. Connecting the call processor 103 to the cable network can be achieve by a number of commercially available solutions, such as are made available from Motorola Broadband USA, or Scientific-Atlanta, USA by way of example.

The call gets to the called telephone 108 via a VER 107 that transforms or decodes the digital call related signals transferred over link 105 from the call processor 103, into traditional telephony signals. The call related signals include for example ring and disconnect, as well as digital voice information. In addition, the VER can convert signals generated by a telephone into digital signals suitable for delivery over link 104 back to call processor 103. Link 104 and link 105 are commonly carried on the physical network. Optionally, VER can be connected to a digital phone and in this case digital signals that are the equivalent of the signals and information described herein are communicated between VER and the digital phone.

According to one embodiment of the invention, VER 107 further comprises logic that, in parallel to transferring certain signals to telephone 108, the VER sends information in digital form over link 112 to TTG 109. This way TTG can keep track of call states (such as ring, answer, busy, hang-up, disconnect, transfer), in real-time.

Further, TTG 109 can send commands to VER 107 over data link 112. These commands are intercepted by additional logic embedded in VER 107. VER 107 potentially can re-code the command into a protocol intercepted by call processor 103, if needed, and send the commands to the call processor 103. The command appears as generated by the subscriber via his or her phone, and it executes the command, casing the desired outcome. Examples of VER to call processor protocols include SIP, MGCP, H.323 and the like.

For example, when a call arrives to a subscriber remote location, normally caller ID (if known) is provided by Call processor 103 to VER 107. VER 107 sends caller ID information over link 112 to TTG 109. TTG 109 then locates the address of Display device 111 associated with telephone number 108, and sends an appropriate command to the Display device 111 to display the caller ID, which in turn, causes caller ID display on TV 110. In this example, device 111 is a digital TV set-top box. In some cases, a specific program should be resident on set-top box 111 in order to intercept the command generated by TTG 109. Alternatively, a Display device can be a PC running a suitable program or a web browser. Multiple Display devices such as TVs and PCs can be associated with a single telephone number 108. In such case, preferably all display devices described will receive messages from the TTG, causing caller ID information to appear on all of them.

Optionally, VER 107 sends additional call related signals to TTG 109, enabling additional applications similar to the caller ID information to be displayed on a Display device or devices. These applications may involve user control over calls by using a remote control unit 114 or any other input device (not shown).

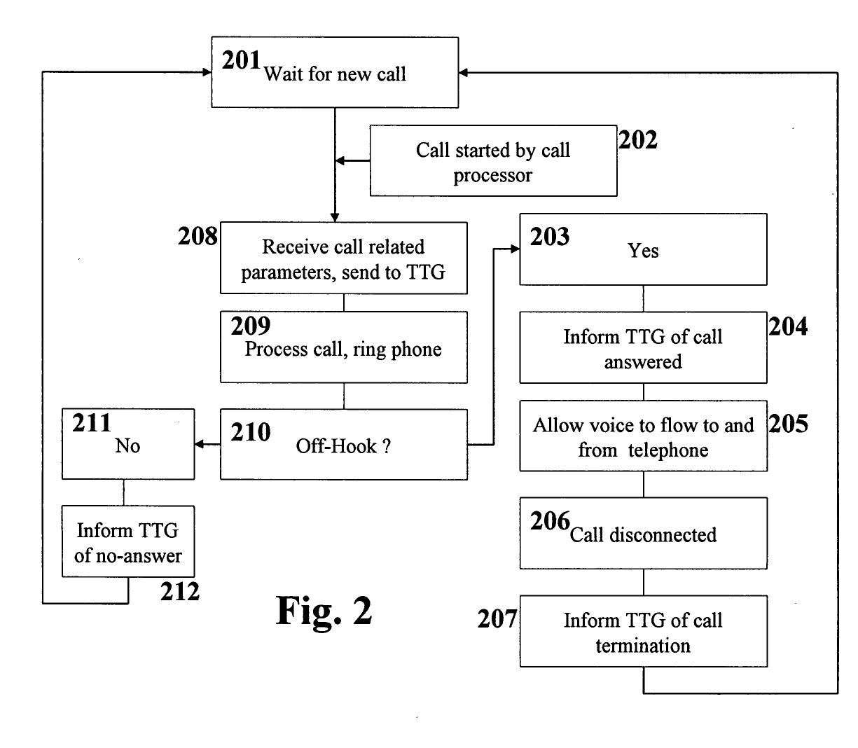

FIG. 2 is an example flow chart of logic added to a VER for the purpose of supporting TTG operations, to be executed during call receiving process according to the preferred embodiment of the invention. These steps or partial steps are described to increase clarity and understanding as to where added logic functions are preferably integrated with existing logic embedded within the VER.

In step 201, the VER is waiting for a new call to arrive from Call processor. Once a call arrives 202, the VER proceeds to step 208, and receives call related parameters such as Caller ID, caller number, and caller name as available. The VER sends the received call parameters to the TTG. In Step 209 the VER causes a phone attached to it to ring. Typically, by the time the telephone rings, the TTG already received the call parameters sent to it by the VER in step 208, and can, in turn, send the call parameters to a display device associated with the user. In step 210, the VER senses if the subscriber answered the call by picking up the telephone. If the subscriber did answer the call, the VER proceeds 203 to step 204 and reports to the TTG that the call was answered. The TTG can then, for example, cause the Display device to stop displaying the caller ID information, as that information is no longer needed. Optionally, the TTG can also insert the caller ID information to a log list containing calls that were answered, optionally with the time of the call. The VER proceeds to step 205, and allows completion of an audio path between the caller and the called.

In Step 206, the VER senses that the call was terminated, and informs the TTG of that fact in step 207. If the subscriber in step 210 did not answer the call, the VER proceeds to reports to the TTG that the call was not answered 212. The TTG can, for example, cause the Display device to eliminate the caller ID information from the display. According to one embodiment of this invention, the TTG can insert the caller ID to a list containing calls that were not answered.

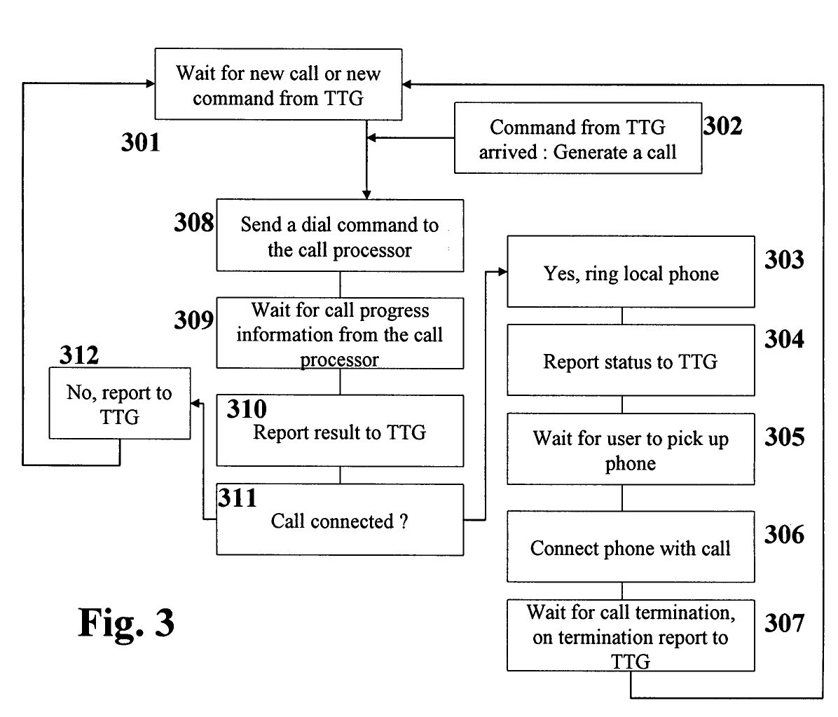

A typical VER is equipped with logic that allows it to execute protocols, coding and decoding operations, and other logic needed to conduct VoIP calls. Additional logic is required in the VER to communicate with a TTG, and to respond to commends therefrom. An example of such logic is depicted in FIG. 3. In state 301, the VER is in a wait state, where it waits for the arrival of a new event or signal. The new event in this example is a command sent from the TTG. In state 302, the VER received a “Generate new call” command from the TTG. Such a command may for example be generated in response to a user issuing a command to the TTG to initiate a call to a number kept in his/her phone book, as displayed by the TTG on a television at the user premises. Thus, the command sent from the TTG to the VER contains the destination phone number to be dialed. In state 308, the VER uses a VoIP protocol to send a dial command containing the destination phone number to the call processor. It should be noted that this dial command is indistinguishable by the Call processor from any other dial command that is sent by the VER following a user manually picking up the phone and dialing a number. Hence the invention emulates the first party, i.e. the telephone user.

In state 309, the VER waits for call progress events from the Call processor. These events track the progress of call set-up process and indicate to the calling party of various success/failure results. In state 310 the VER, reports call progress results received from the call processor to the TTG. In state 311 the VER distinguishes between a code that indicates call establishment success and a code or codes that indicate call establishment failure. On state 312, a failure, and optionally the reason for failure, is reported to the TTG, prior to returning to state 301 to await a new call or event. According to one embodiment of the invention, the TTG displays the cause of the error on the user's television, and the user is given the opportunity to re-try the same number, dial another number, or abort the call attempt.

If the call establishment succeeds, 303, the VER causes the user's phone coupled thereto to ring, to indicate the call is on the line. The VER also reports to the TTG about the status of the call (state 304). In state 305, the VER waits for the user to pick up the phone, which completes the end-to-end telephone session establishment 306. In state 307, the VER waits for the completion of the call, reports completion status to TTG, and goes back to wait state 301.

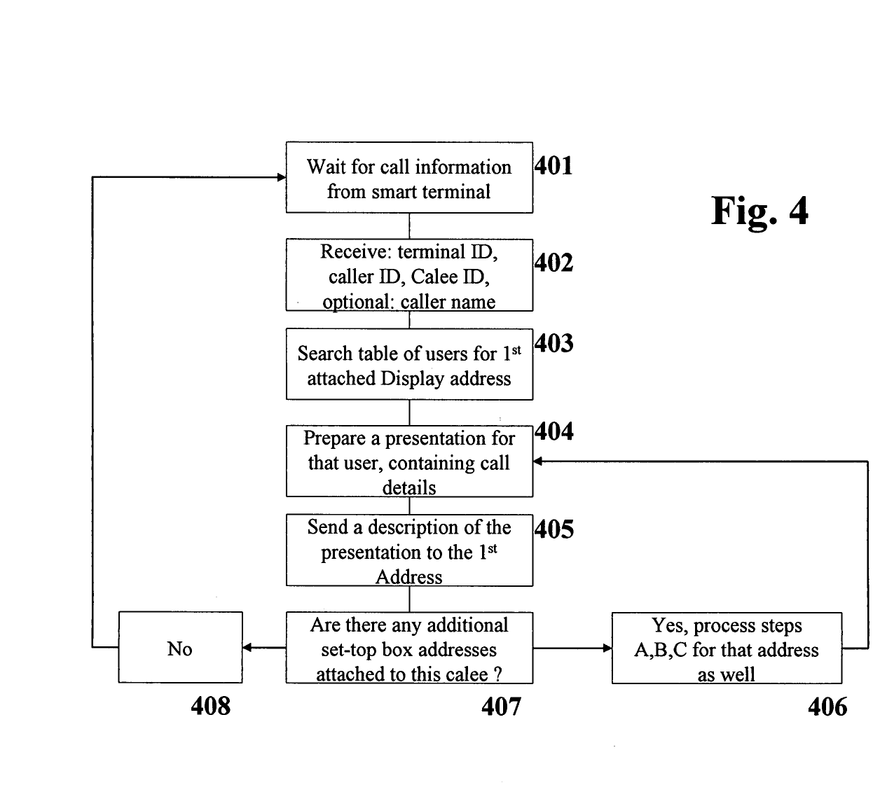

FIG. 4 depicts a flow chart example of a program embedded in the TTG to provide a caller ID on a Display device, working in conjunction with a VER.

In state 401 the TTG is waiting for a new signal, such as a new call arrival signal from a VER associated with a subscriber. Typically, the signal contains caller ID information, called party information, the originating VER ID, and optional fields such the caller name. This information is received by the TTG in stage 402. In stage 403 the TTG searches a data table, preferably stored as a data-base that contains a list having one or more entries of display addresses associated with the originating VER. In state 404, the TTG prepares a presentation to be displayed on the first Display device in the list, and in state 405 TTG sends the presentation (e.g. by generating a video signal), or instructions to create the presentation, to the first Display device associated with the originating VER. Sending the presentation or graphic instructions causes the first Display device to show the presentation. The presentation may take any convenient form, for example switching on a light on the display device, display an icon, text, or graphics display on a screen, produce an audible warning, and the like. Preferably, the presentation contains information regarding the caller ID, caller name (if known) and potentially other items such as service provider logo, picture of the caller, advertisement, day and time and any other data or graphic item related to the call as desired. In step 407 the TTG looks for additional display devices associated with the originating VER. If such additional Display devices exist in the list, the TTG continue to execute at state 404 and repeats the presentation process for each of the associated display devices. If no additional Display devices are in the list, the TTG executes step 401 and awaits another call event.

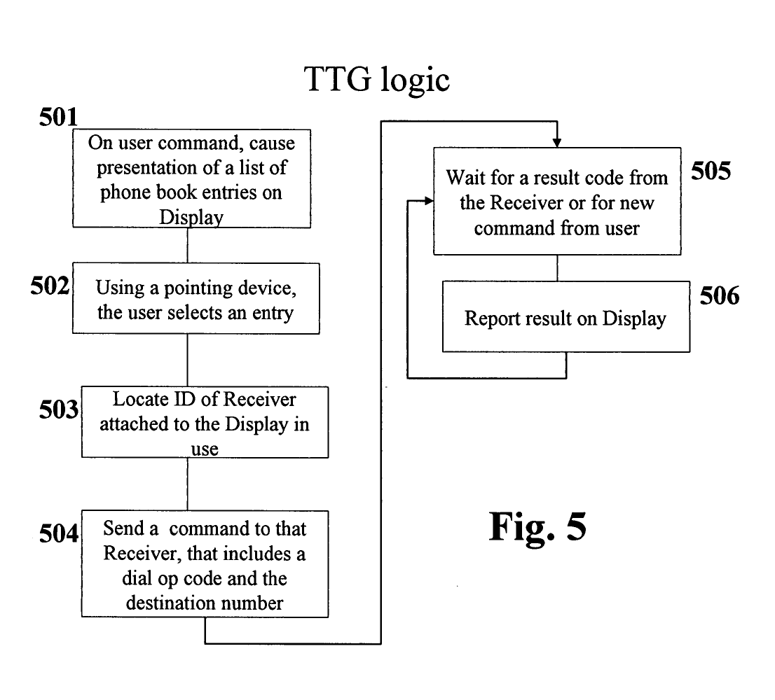

FIG. 5 depicts an example of a program embedded in the TTG to provide a dial by phone book capability. In this example, the sequence of events starts at step 501, where a user, preferably using a pointing device, commands the TTG to display a list of phone book entries. The phone book entries can be stored locally in the Display device, in a local data store coupled to the display device, or centrally coupled to, or embedded within, the TTG. Following the user command, the TTG causes the Display to show the user entries taken from the stored phone book. In step 502, the user browses through the list, and selects an entry. In step 503, the TTG, by searching through a list associating VER's and display devices, locates the VER associated with the Display from which the command issued. In state 504, The TTG sends a command to the associated VER. The command contains a code that is translated by the VER as a dial command, and a destination number. In state 505, the TTG waits for a return code from the VER, or for a new command from the user. An example for a new command from the user may be to cancel the dial operation which will cause the TTG to send additional ‘cancel’ command to the VER. While the TTG waits in state 505, the VER receives 520 the command sent to it by TTG in state 504. The rest of flow logic shown is similar to the logic presented in FIG. 3.

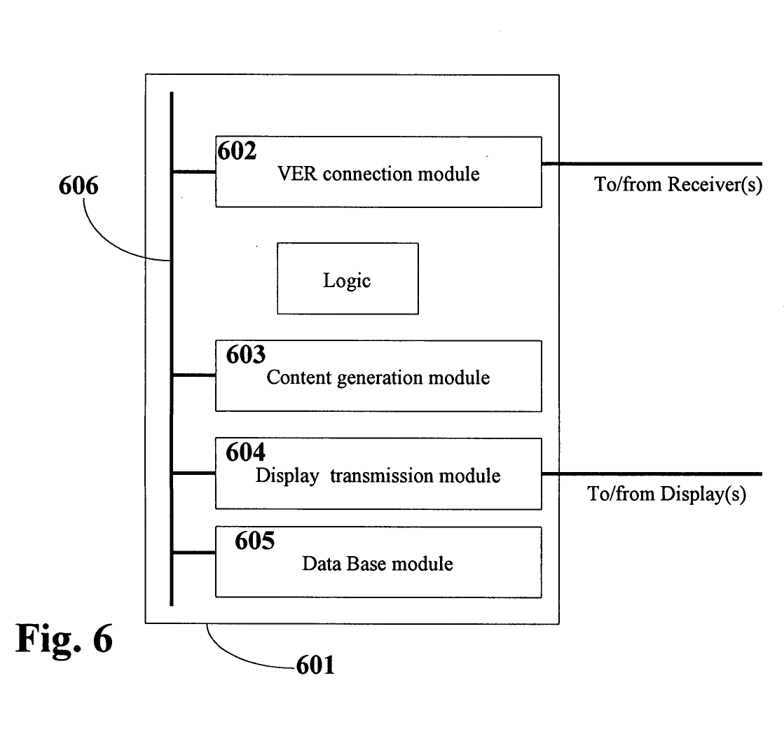

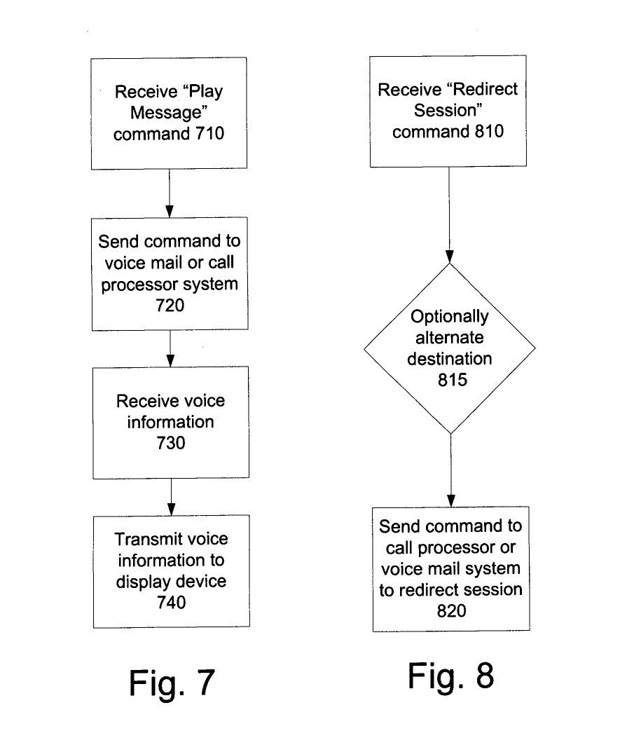

FIG. 6 is a schematic diagram of one embodiment of a TTG. Preferably, the TTG comprises four modules. While it is understood that each module can be a separate computer, as shown in this figure, it is possible to have one or more of these modules running on the same computer, or specialized hardware, as convenient. Module 602 contains logic to interact with VERS. Typically this module contains two network interfaces. One to communicate with the VER's and the other to connect to the local LAN. However it is also common to have the VER's communications be coupled via the LAN, and therefore a single interface will sufficed. Module 603 contains logic to generate appropriate presentations for the different display devices. This module generates displays presentation information that may be generated as video signal, display instructions that a display device can operate upon to cause a display of the information upon command, or any other conversion needed to convey call related information on a display device. Display module 604 communicates with the Display devices, and conveys to them the Displays presentation information generated by module 603. Preferably this module contains two network interfaces, one to communicate with the local LAN 606 and one to communicate with the Display devices. Data base module 605 is a storage module. Here, according to this embodiment, the lists that associate VER's with one or more display devices, as well as other application related logic and information are stored.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

What is claimed is:

1. A system for viewing of selected telephone call parameters and controlling phone calls, comprising:
at least one Voice Over Internet Protocol enabled receiver, located at a subscriber premises;
a display device coupled to a television distribution network;
a TTG (Telephony-Television Gateway) located remotely to said subscriber premises, and being in communication with said receiver, the TTG being further coupled with said display device via said network;
wherein said TTG is capable of receiving information related to a telephony session from said Receiver and transfer said information, or a portion thereof, to said display device.

2. A system as claimed in claim 1, wherein said TTG is coupled to a telephony call processor.

3. A system as claimed in claim 2 wherein said TTG is constructed to receive user commands from a user, and direct said commands to said telephony call processor.

4. A system as claimed in claim 3, wherein said commands are selected from a group consisting of commands to disconnect a telephony session, commands to direct a telephony session to voice mail, commands to direct the telephony session to a specific telephone, commands to play a message to a caller, or a combination thereof.

5. A system as claimed in claim 3 wherein said TTG is coupled, or contains, a voice mail system, and wherein the TTG is adapted to transmit content of a voice message recorded by said voice mail system to said display device.

6. A system as claimed in claim 5, wherein the TTG is further adapted to transmit said content while said voice message is being recorded.

7. A system as claimed in claim 6, wherein said TTG is further adapted to instruct said telephony system to redirect a session to said receiver or to an alternative receiver, or to an alternative telephony device, responsive to a user command.

8. A system as claimed in claim 1, further comprising an input device for receiving input from a user.

9. A system as claimed in claim 1, wherein said display device is a television coupled to a set-top box.

10. A system as claimed in claim 9, wherein said receiver is housed in said set-top box.

11. A system as claimed in claim 1 wherein said receiver is a cable modem.

12. A system as claimed in claim 1 wherein said receiver is a computer.

13. A system as claimed in claim 1 wherein said display device is a computer.

14. A system as claimed in claim 1 wherein said display device is a video monitor.

15. A system as claimed in claim 1, wherein said TTG is adapted to send commands to said receiver

16. A system as claimed in claim 15 wherein said commands comprise a command to initiate a telephone call.

17. A system as claimed in claim 1, wherein said TTG is further adapted to display advertisements on said display device.

18. A system as claimed in claim 17 wherein said display of advertisement is combined with the display of said information.

19. A Voice Over Internet Protocol Enabled Receiver, comprising:
a receiver adapted to receive packets containing telephony call information comprising voice data and call control data, said receiver further adapted to convert the voice data into an audio signal suitable for reproduction on a telephony device;
an IP transmitter adapted to receive voice from said telephony device and convert said voice into outgoing voice data packets, and transmit said outgoing packets;
a control data transmitter module adapted to, directly or indirectly, send said call control data, or a portion thereof, to a remote TTG (Telephony-Television Gateway) adapted to cause displaying of at least a portion of said call control data on a display device.

20. A TTG (Telephony-Television Gateway) comprising:
a connection module couplable to a plurality voice over internet protocol enabled receivers, and receive session related information from at least one of said receivers;
a display transmission module couplable to a television distribution network having a plurality of addressable remote display devices via a television distribution network; and
logic, implemented in hardware or in software, adapted to transfer said session related information or a portion thereof, from said connection module to said display transmission module for transmission to at least one selected display device, via said network.

21. A TTG as claimed in claim 20, further comprising a content generation module adapted to convert said information into a format appropriate for transmission to said selected display device prior to transmitting the converted information or a portion thereof.

22. A TTG as claimed in claim 20, further comprising a database module, adapted to query a database for correlation between said receiver and at least one display devices.

23. A TTG as claimed in claim 20, further comprising:
a content generation module adapted to convert said information into a format appropriate for transmission to said selected display device prior to transmitting the converted information or a portion thereof; and,
a database module, adapted to query a database for correlation between said receiver and at least one display devices.

24. A TTG as claimed in claim 20 further adapted to display advertisement information on the display device, combined with said information.

25. A TTG as claimed in claim 21 further adapted to display advertisement information on the display device, combined with said information.

26. A TTG as claimed in claim 23 further adapted to display advertisement information on the display device, combined with said information.

27. A TTG as claimed in claim 26 wherein said advertisement is selected to conform to a profile associated with said receiver or said display device.

28. A TTG as claimed in claim 20 further adapted receive commands from a user and transfer said commands to a telephony call processor.

29. A TTG as claimed in claim 20 further adapted to receive commands from a user and to transfer said commands to said receiver.

30. A method for providing VoIP based telephone call control to a subscriber, the method comprises the steps of:
at a subscriber premises, receiving packets comprising call control data in a VOIP enabled receiver;
transmitting said packets or a portion thereof to a predetermined central telephony-television gateway (TTG) coupled to a television or data distribution network; and,
from said gateway, sending a signal adapted to cause display of said call control information or a portion thereof on a display device at said user premises, preferably via said television distribution network.

31. A method as claimed in claim 30 wherein said signal is transmitted via said network.

32. A method as claimed in claim 30 further comprising the step of receiving commands from a user, and using said commands to direct operations at a call processor.

33. A method as claimed in claim 32 wherein said commends are selected from a group consisting of commands to disconnect a telephony session, commands to direct a telephony session to voice mail, commands to direct the telephony session to a specific telephone, commands to play a message to a caller, or a combination thereof.

34. A method as claimed in claim 30 further comprising the steps of:
recording a voice-mail message; and,
relaying the content of said message to said display device.

35. A method as claimed in claim 34, wherein said step of relaying is performed while said message is being recorded.

36. A method as claimed in claim 34, further comprising the steps of: redirecting a telephony session in the process of voice mail recording to said receiver, or to an alternative receiver or to a telephony device, in response to a user command.

37. A method as claimed in claim 30, wherein said display device is a television coupled to a set-top box.

38. A method as claimed in claim 30 wherein said receiver is housed in a set-top box.

39. A method as claimed in claim 30 wherein said receiver is a cable modem.

40. A method as claimed in claim 30 wherein said receiver is a computer.

41. A method as claimed in claim 30 further comprising the step of sending commands from said TTG to said receiver.

42. A method as claimed in claim 41 wherein said command being sent to said receiver instructs the receiver to initiate a telephone call.

43. A method as claimed in claim 30 further comprising the step of displaying advertisement on said display device.

44. A method as claimed in claim 43 wherein said advertisement is combined with the display of said call control information.

45. A method as claimed in claim 43 further comprising the step of selecting said advertisement in accordance with a profile associated with said display device or with said receiver.

46. A method as claimed in claim 30 further comprising the step of converting said call control information into a format appropriate for transmission to said display device.

47. A method as claimed in claim 30 wherein said call control information comprises information about the calling telephone number.

48. A method as claimed in claim 30 wherein said call control information comprises information about the identity of the calling party.
